(19) United States
(12) Patent Application Publication
(10) Pub. No.: US 2007/0257223 A1
(43) Pub. Date: Nov. 8, 2007

(54) Valve assembly

(76) Inventors: Frank van de Moosdijk, Gravendeel (NL); John L. van de Moosdijk, Kalmthout (BE)

Correspondence Address: Scott David Compton;#593, 2386 South Dairy Ashford Road, Houston, TX, 77077, US

(21) Appl. No.: 11/430,033

(22) Filed: May 8, 2006

(51) Int. Cl. F16K 1/16

(52) U.S. Cl. 251/300

(57) ABSTRACT

A valve assembly comprising a body; a fluid flow passage extending there through; a lift fork pivotally attached to the body at a first end; and a poppet attached on its fluid flow passage side to a second end of the lift fork wherein the lift fork is configured to displace the center of the poppet to about the perimeter of the fluid flow passage.

### FIELD OF THE APPLICATION

The application relates generally to a valve assembly for controlling the transfer of fluids.

### BACKGROUND

Industrial and commercial type valves such as foot valves generally comprise an inlet and an outlet for fluid transfer. Fluid transfer is typically controlled in these type of valves using a poppet or sealing member that is attached to a pivotal arm or lift fork and is engageable with and displaceable from either the inlet or outlet as determined by the configuration of the lift fork. Unfortunately, the configuration of the lift fork in known valves does not afford displacement of the poppet out from the flow path of fluid being transferred through the inlet or outlet when the valve is in an open position. Instead, the poppet and lift fork remain in the fluid flow path, thus inhibiting the flow rate of the fluid.

A valve is desired that comprises a poppet and lift fork that can be displaced from the fluid flow path for unobstructed fluid flow through the valve.

### SUMMARY

The present application is related to a valve assembly for controlling the transfer rate of fluid through the valve assembly. The valve assembly comprises: a body; a fluid flow passage extending there through; a lift fork pivotally attached to the body at a first end; and a poppet attached on its fluid flow passage side to a second end of the lift fork wherein the lift fork is configured to displace the center of the poppet to about the perimeter of the fluid flow passage.

### BRIEF DESCRIPTION OF THE FIGURES

FIG. 1 illustrates a perspective view of the valve assembly with the poppet in an open position.

FIG. 2 illustrates a top view of the valve assembly with the poppet in an open position.

FIG. 3 illustrates an exploded view of the valve assembly.

FIG. 4 illustrates a cross-sectional side view of the valve assembly with the poppet in an open position.

FIG. 5 illustrates a cross-sectional side view of the valve assembly with the poppet in a sealed position.

FIG. 6 illustrates a perspective view of the actuating member and fulcrum.

FIG. 7 illustrates a perspective view of the actuating assembly and resilient member.

FIG. 8 illustrates a top view of the primary connection member with the poppet in an open position.

FIG. 9 illustrates a cross-sectional side view of the valve assembly including the flow path of fluid being transferred through the valve assembly.

### DESCRIPTION

It has been discovered that the configuration of a valve assembly, including the configuration of the lift fork in combination with the point of attachment of the lift fork to the body of the valve assembly, determines the furthest point of displacement of the poppet out from the fluid flow passage of the valve assembly. Heretofore, such a desirable achievement has not been considered possible, and accordingly, the valve assembly of this invention measures up to the dignity of patentability and therefore represents a patentable concept.

In one aspect, the present application relates to a valve assembly configured to control the transfer rate of fluid through the valve assembly either into or out of a container. In another aspect, the application relates to a valve assembly configured to increase the amount of displacement of a poppet over known valves by displacing the poppet out from the fluid flow passage for unobstructed fluid flow through the fluid flow passage of the valve assembly. In yet another aspect, the application relates to a valve assembly configured to seal various parts of the valve assembly from the fluid being transferred through the fluid flow passage. The valve assembly according to the present application will be described in more detail with reference to the embodiments illustrated in the drawings. The drawings are illustrative only, and are not to be construed as limiting the invention, which is defined in the claims.

The Valve Assembly

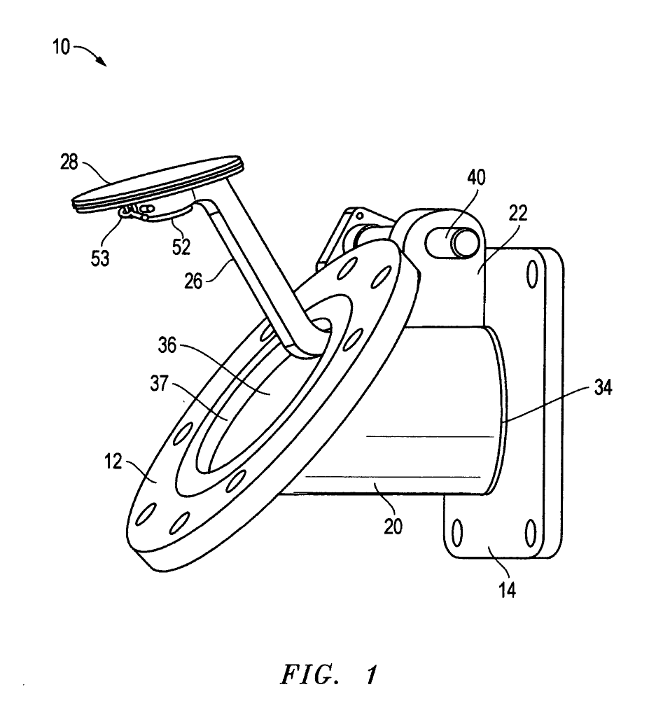

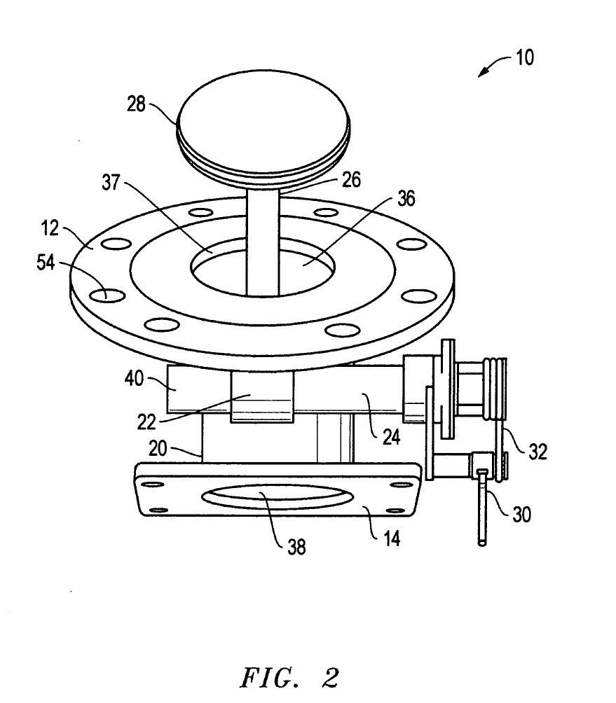

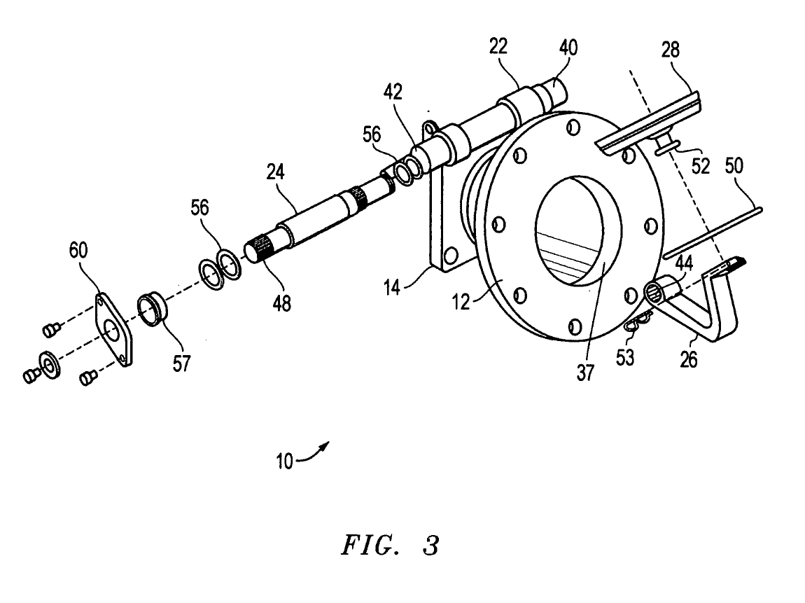

The Figures of the drawings, and particularly FIG. 1, disclose a valve assembly 10. The valve assembly 10 comprises (1) a body including a primary connection member 12 configured to attach to a container, a secondary connection member 14 configured to attach to an outlet, and a conduit 20 defined by a surface which surrounds the conduit, wherein the conduit extends to the primary connection member 12 at one end and to the secondary connection member 14 at an opposing end—the body of the valve assembly 10 being defined by a fluid flow passage there through. The valve assembly further comprises (2) a fork compartment 22 adjacent and in fluid communication with conduit 20; (3) a spindle 24 pivotally mounted through fork compartment 22 (see FIG. 3), (4) a lift fork 26 pivotally attached to the body of the valve assembly via spindle 24 at a first end, (5) a poppet 28 attached on its fluid flow passage side to a second end of lift fork 26, (6) an actuating member 30 for pivoting spindle 24 (see FIG. 2), (7) a resilient member 32 configured to force said poppet 28 to a sealed position with the fluid flow passage of the body of the valve assembly 10 (see FIG. 6), and optionally (8) a shear section 34 positioned along the periphery of conduit 20 at a point where conduit 20 attaches to secondary connection member 14.

The term “container” herein refers to any tank or vessel suitable for storing fluids. The term “outlet” herein refers to a connection including, for example, a pipe, hose, valve or other fluid communication device allowing complete and uninterrupted flow of fluid through secondary connection member 14 for receiving fluid from a container, or for transferring fluid to a container. The term “fluid” herein refers to any flowable material including, for example, liquids, gases, flowable solids, pastes and super critical fluids. Flowable solids are further defined as solid materials (e.g., crystals, powders, pellets, granules, etc.) that can move in an uninterrupted flow through the valve assembly 10. The term “seal” or “sealing” herein refers to securing fluid within a container without passing any fluid through the valve assembly 10.

The dimensions of valve assembly 10, including the inner diameter of the conduit 20, can vary depending on (a) the type of fluid being transferred through the valve assembly 10, (b) the flow requirements of the fluid (e.g., viscosity), (c) the pressure capacity of the container, and (d) the temperature capacity of the container. Suitably, the valve assembly 10 is configured to operate at a pressure from about 1 bar to about 10 bar. In a particularly advantageous embodiment, the valve assembly 10 is configured to operate at a pressure of about 10 bar (about 145 psi).

The primary connection member 12 is comprised of a flange or other connection profile configured to attach and seal the valve assembly 10 to a relatively flat surface of a container. Suitably, the valve assembly 10 is sealably attached to a container using bolts passing through equally angularly spaced bolt apertures 54 of primary connection member 12. Although the conduit 20 can extend from primary connection member 12 in any number of orientations, when the primary connection member 12 is attached to a container, the conduit 20 suitably extends from primary connection member 12 so that the axis of the conduit 20 is about parallel to the ground or floor—which allows for a suitable connection of secondary connection member 14 to an outlet. Thus, depending on the point of attachment of the primary connection member 12 to a container, the conduit 20 can be bent, lengthened or otherwise manipulated to maintain the axis of conduit 20 about parallel to the ground or floor at least at a point of attachment of the conduit 20 to secondary connection member 14. For example, the angle of attachment of primary connection member 12 to conduit 20 can range from about 0° to about 90° relative to the axis of the conduit 20 when the primary connection member 12 is attached to a container whether attached about vertically to a sidewall of the container or about horizontally to the underside or topside of the container.

For most applications a suitable angle of attachment of primary connection member 12 to conduit 20 is from about 30° to about 45° relative to the axis of the conduit 20. Where the angle of attachment to conduit 20 is greater than about 45°, it may be necessary to lengthen and bend the conduit 20 up to about 90° to accommodate an outlet for suitable release of fluid from the container.

Primary connection member 12 is further defined by an opening 36 there through which lies in fluid communication with both the container and conduit 20. Suitably, opening 36 comprises a diameter about the diameter of conduit 20 and a diameter up to about the diameter of the container outlet. Also, the diameter of opening 36 is about the diameter of poppet 28. In a particularly advantageous embodiment, opening 36 suitably comprises a round sealing surface 37 that tapers outward and is configured to form a seal with poppet 28.

The primary connection member 12 is not limited to any particular outer diameter, but can vary depending on the application. For most commercial applications, a suitable outer diameter of primary connection member 12 is from about 20 cm to about 40 cm. In another embodiment, the outer diameter of primary connection member 12 is from about 20 cm to about 30 cm. In a particularly advantageous embodiment, the outer diameter of primary connection member 12 is about 25 cm (about 9⅘ inches).

As stated above, conduit 20 is in fluid communication with primary connection member 12 at a first end via opening 36. Conduit 20 is also in fluid communication with secondary connection member 14 at a second end via opening 38 (see FIG. 2)—this allows fluid to be transferred through the valve assembly 10 in either direction past openings 36 and 38 thereby defining a fluid flow passage through the body of valve assembly 10.

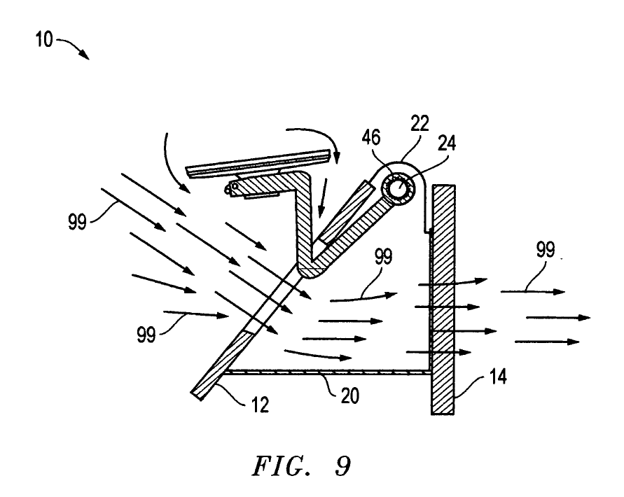

In one embodiment, the inside surface of the conduit 20 is tubular and comprises a diameter about the diameter of openings 36 and 38. In addition, where primary connection member 12 attaches to conduit 20 at an angle from about 30° to about 45°, the body of the valve assembly 10 comprises a spacing 16 along the periphery connecting primary connection member 12 and conduit 20, as shown in FIG. 8. In a particularly advantageous embodiment, the spacing 16 between circular opening 36 and circular conduit 20 comprises an elliptical profile. The elliptical configuration of spacing 16 allows for uninterrupted flow of the fluid through valve assembly 10.

Conduit 20 can comprise any length and outer design suitable for valve assembly operation. In a suitable embodiment, conduit 20 comprises an outer tubular design. For most commercial applications, a suitable length of conduit 20 is from about 12 cm to about 15 cm. In a particular advantageous embodiment, the length of conduit 20 is about 13.6 cm (about 5⅜ inches). Ultimately, the length of conduit 20 is determined by (1) the size and length of the fork compartment 22, and (2) the configuration of the container at the attachment point with the valve assembly 10 (note—some containers include a cavity section in the container wall at the attachment point for a valve).

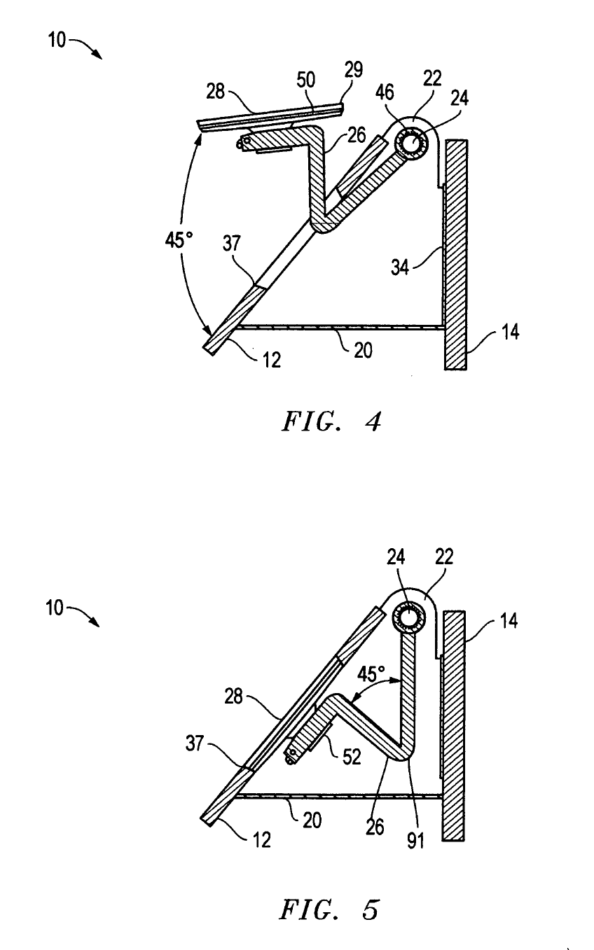

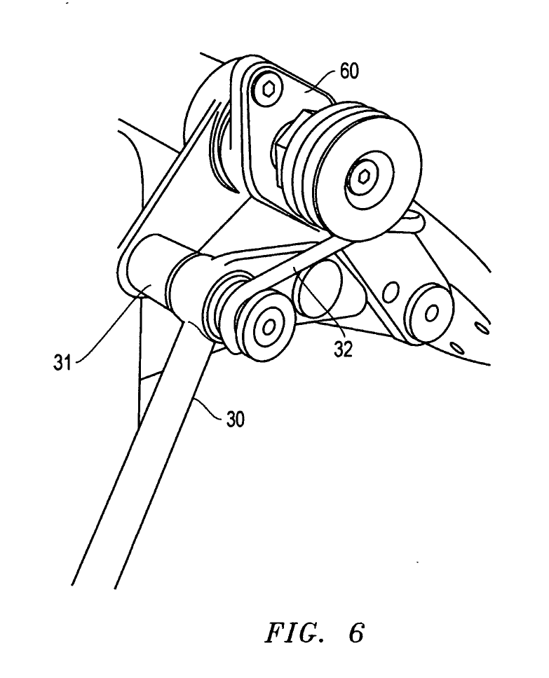

Suitably, secondary connection member 14 is comprised of a flange or other connection profile configured to connect to an outlet. As stated above, secondary connection member 14 is defined by an opening 38 there through for receiving and/or discharging fluid. Suitably, the angle of attachment of secondary connection member 14 to conduit 20 can range from about 0° to about 90° relative to the axis of the conduit 20. In a particularly advantageous embodiment of the valve assembly 10, as shown in FIGS. 4 and 5, the planes defining openings 36 and 38 comprise a non-parallel relationship wherein at least the plane defining either opening 36 or 38 comprises an oblique angle in relation to the axis of conduit 20.

In one embodiment, valve assembly 10 comprises a seamless connection between secondary connection member 14 and conduit 20. In a particularly advantageous embodiment, secondary connection member 14 is attached to conduit 20 via shear section 34. Shear section 34 is configured to serve as a breakage groove to protect the valve assembly 10, less the secondary connection member 14, from accidental damage. Suitably, secondary connection member 14 can be configured to be released from valve assembly 10 upon shearable contact by an external force.

As shown in FIGS. 1 and 2, the fork compartment 22 is located at a point between primary connection member 12 and secondary connection member 14 adjacent and in fluid communication with conduit 20. Suitably, fork compartment 22 is configured so that the lift fork 26 can be affixed to the body of the valve assembly 10 via spindle 24 at a point within the fork compartment 22, as shown in FIG. 4. Specifically, fork compartment 22 is configured (1) to mount at least a section of spindle 24 there through, and (2) to house at least a section of lift fork 26 at an attachment point to spindle 24. A shown in FIGS. 4 and 5, fork compartment 22 comprises a hollow chamber configured to allow pivoting of the lift fork 26 towards primary connection member 12 along the length of conduit 20.

In addition, fork compartment 22 can comprise parallel sidewalls, or in the alternative, the sidewalls can be wider at the point of attachment to conduit 20 than near the mounting point of spindle 24 through fork compartment 22. In a particularly advantageous embodiment, fork compartment 22 comprises an apex configuration wherein spindle 24 is pivotally mounted through the apex of fork compartment 22. The apex configuration allows lift fork 26 to pivot about spindle 24 through an increased range within the fork compartment 22 and conduit 20 as compared to a fork compartment 22 comprising parallel sidewalls.

As stated above, the range of motion for pivoting the lift fork 26 is dependent, in part, on the configuration of valve assembly 10 including (1) the size and shape of fork compartment 22, (2) the size and shape of the lift fork 26, and (3) the angle of attachment of primary connection member 12 to conduit 20. Suitably, the fork compartment 22 is configured so that the lift fork 26 can pivot within the fork compartment 22 up to about 100°. In a particularly advantageous embodiment, where primary connection member 12 comprises an angle of attachment to conduit 20 of about 45° relative to the axis of the conduit 20, the lift fork 26 can comprise a range of motion up to about 45° within fork compartment 22—as shown in FIG. 4. One embodiment of a suitable fork compartment 22 comprises an inside depth from about 4 cm to about 6 cm; comprises a length along conduit 20 from about 4 cm to about 6 cm; and comprises a width from about 2 cm to about 4 cm.

As stated previously, the axis of conduit 20 is configured to extend from primary connection member 12 about parallel to the ground or floor for attaching to secondary connection member 14. Thus, as the angle of attachment of the primary connection member 12 to conduit 20 varies from about 45°, the conduit 20 and fork compartment 22 can be bent, lengthened or otherwise manipulated to maintain the parallel orientation of the axis of conduit 20 with the ground or floor and to ensure proper spacing for pivoting of the lift fork 26.

For example, where the primary connection member 12 comprises an angle of attachment to conduit 20 greater than 45° relative to the axis of the conduit 20, the valve assembly 10 comprises (1) a lengthened conduit 20, and (2) a lengthened fork compartment 22 along the conduit 20 from about the spindle 24 towards the secondary connection member 14. Where the primary connection member 12 comprises an angle of attachment to conduit 20 less than about 30° relative to the axis of conduit 20, the conduit 20 can comprise a bend up to about 90° to maintain the parallel relationship of the axis of the conduit 20 with the ground or floor at the point of attachment to secondary connection member 14.

As shown in FIGS. 2 and 3, spindle 24 is configured to extend across valve assembly 10 through fork compartment 22 perpendicular to the axis of conduit 20. Spindle 24 is connected to actuating member 30 at a first end as the second end of spindle 24 extends into a housing 40, suitably a tubular housing, projecting outwardly from the main portion of the valve assembly 10. The portion of spindle 24 that extends towards actuating member 30 passes through a bore 42 wherein spindle 24 comprises about the same diameter as bore 42 to maintain alignment of the spindle 24 with bore 42. Suitably, spindle 24 is physically isolated from the fluid being transferred through the fluid flow passage of the body of valve assembly 10.

As shown in FIG. 3, spindle 24 and lift fork 26 are removable from valve assembly 10. In a particularly advantageous embodiment, valve assembly 10 comprises a first packing arrangement including one or more o-rings 56 (e.g., PTFE o-rings or the like). Likewise, valve assembly 10 comprises a second packing arrangement including a combination of one or more o-rings 56, a spindle bush 57, and optionally one or more gasket materials. First and second packing arrangements are configured to seal and maintain proper alignment of the spindle 24 during rotation of the spindle 24 within housing 40. The second packing arrangement is further secured by clamp plate 60, which is fastened to valve assembly 10 by fastening means such as bolts or screws. In a particularly advantageous embodiment, clamp plate 60 is fastened to valve assembly 10 by hexagon bolts, more specifically, hexagon sinked m6 bolts.

The point where bore 42 meets fork compartment 22 comprises an enlarged diameter of bore 42 to accommodate the attachment of lift fork 26 to spindle 24. In a particularly advantageous embodiment, a first end of lift fork 26 includes an aperture 44 configured to secure the lift fork 26 to a section of spindle 24. The aperture portion of the lift fork 26 is provided with an internally splined portion 46 which is located over a complimentary splined portion 48 of spindle 24. Suitably, as spindle 24 turns, the complimentary splined portion 48 acts upon the splined portion 46 of lift fork 26, thus pivoting lift fork 26 about spindle 24 within fork compartment 22 along a predetermined range. As shown in FIG. 4, the attachment of the first end of lift fork 26 to spindle 24 at the apex of fork compartment 22 provides a lift fork configuration wherein lift fork 26 can be pivoted toward primary connection member 12 to a point where a section of lift fork 26 abuts sealing surface 37.

In one embodiment, the lift fork 26 is configured to displace the center of the poppet 28 to about the perimeter of the fluid flow passage of the body of valve assembly 10. In another embodiment, the lift fork 26 is configured to displace the poppet 28 to an open position wherein the poppet 28 is substantially removed from the fluid flow passage of the body of the valve assembly 10 to allow unobstructed fluid flow through the fluid flow passage.

In another embodiment, the lift fork 26 is configured to displace the center of the poppet 28 from a first sealed position abutting the sealing surface 37 to a second open position at a point off-center from opening 36 wherein the poppet 28 is substantially removed from opening 36 to allow unobstructed fluid flow through the opening 36. In a particularly advantageous embodiment, the lift fork 26 is configured to displace the poppet 28 from a first sealed position abutting the sealing surface 37 to a second open position wherein the center of the poppet 28 is displaced off-center from the opening 36 to about the perimeter of opening 36 or to about the sealing surface 37.

As shown in FIG. 5, the lift fork 26 comprises at least a first section for attachment to spindle 24 and a second section for attachment to poppet 28. In addition, the first and second sections of lift fork 26 are configured to extend from their attachment points to spindle 24 and poppet 28 and join at a point within conduit 20—herein referred to as junction 91. In a suitable embodiment, the first and second sections of lift fork 26 join at junction 91 in a manner to form a lift fork 26 having one or more of the following shapes: curved, bent, angled, and mitered. In a particularly advantageous embodiment, the shape of lift fork 26 comprises an acute angle wherein the lift fork 26 is configured to displace the center of the poppet 28 to about the perimeter of the fluid flow passage of the body of the valve assembly 10.

In one embodiment, the angle of lift fork 26 is from about 30° to about 45°. In a particularly advantageous embodiment, the angle of lift fork 26 is about 45°. It is the configuration of the valve assembly 10, including the configuration of the fork compartment 22 and the shape of the lift fork 26 in combination with the point of attachment of the lift fork 26 to the body of the valve assembly 10 via spindle 24 that determines the amount of displacement of the center of the poppet 28 off-center from the opening 36.

The diameter or width of lift fork 26 can vary depending on the size and shape of valve assembly 10. In one example of a suitable embodiment, lift fork 26 comprises a diameter or width from about 1 cm to about 2 cm. In a particularly advantageous embodiment, the lift fork 26 comprises a diameter or width of about 1.9 cm (about ¾ inches).

As shown in FIGS. 4 and 5, poppet 28 is configured to attach on its fluid flow passage side to lift fork 26. Poppet 28 suitably comprises at least a body 29 and a sealing ring 50, wherein the body 29 is tapered along its outer periphery to sealingly abut sealing surface 37. In one embodiment, poppet 28 attaches to lift fork 26 via a boss 52 extending from about the center of the fluid flow passage 20 side of body 29. The boss 52 is configured so that the poppet 28 is releasably attached to the lift fork 26 via one or more fasteners 53—as shown in FIGS. 1 and 3. Suitably, the boss 52 comprises a diameter or width less than the diameter of body 29.

Suitably, the body 29 of poppet 28 is disc-like in construction. In one embodiment, the poppet 28 and boss 52 are one-piece construction. In another embodiment, boss 52 is welded to the body 29 of the poppet 28. Suitably, poppet 28 and boss 52 can be comprised of the same materials as the valve assembly 10 (discussed below). A suitable fastener 53 includes, for example, a hair pin cotter comprising one or more humps. In an advantageous embodiment, fastener 53 comprises a hair pin cotter comprising two or more humps for securing poppet 28 to lift fork 26 during operation of the valve assembly 10.

For most commercial applications, a suitable diameter of poppet 28 is from about 1 cm to about 15 cm. In another embodiment, the diameter of poppet 28 is from about 6 cm to about 12 cm. In a particularly advantageous embodiment, the diameter of poppet 28 is about 8 cm (about 3⅙ inches).

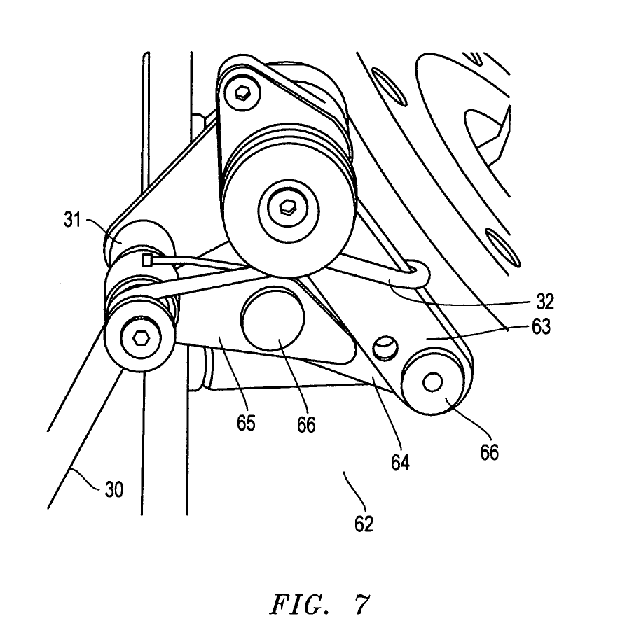

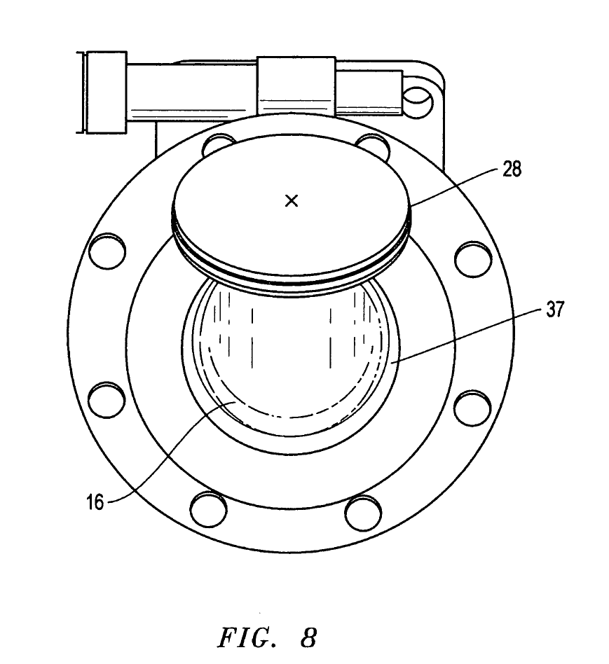

To form and maintain a seal between poppet 28 and sealing surface 37, the poppet 28 is either (1) urged towards sealing surface 37 by a resilient member 32 acting on spindle 24, or (2) locked in a sealed position with sealing surface 37. In a suitable embodiment, poppet 28 is urged towards sealing surface 37 by a resilient member 32 attached to the exterior of the body of the valve assembly 10 and linking the spindle 24 to actuating member 30. In a particularly advantageous embodiment, the resilient member 32 is configured to (a) spool or hook around an actuating assembly 62 (see FIG. 7) at a first end, (b) spool or hook around spindle 24 along the length of resilient member 32, and (c) spool or hook around a fulcrum 31 at a second end—the fulcrum 31 configured to extend out from the exterior of the body of the valve assembly 10.

As actuating member 30 is motioned towards an open position of the valve assembly 10, the resilient member 32 is extended producing a torque on the resilient member 32. As actuating member 30 is motioned towards a sealed position, the resilient member 32 is untorqued as the hooks are returned to their starting position. As shown in FIG. 6, resilient member 32 is located external of the fluid flow passage thereby isolating the resilient member 32 from any fluid flowing there through.

A suitable resilient member 32 includes, for example, a spring configured to urge poppet 28 towards sealing surface 37 by acting on spindle 24. Suitable springs include, for example, tension springs such as helical and cylindrical springs. A desirous spring can be made from any material durable enough to withstand constant displacement of poppet 28 from sealing surface 37 during the usable life of the valve assembly 10. In addition, the valve assembly 10 is configured so that resilient member 32 can be removed and replaced. A suitable spring material includes, for example, stainless steel.

As shown in FIG. 6, actuating member 30 includes, for example, a lever or arm comprising an aperture configured to attach to fulcrum 31. Suitably, the lever or arm of actuating member 30 is configured to be motivated by hand or by other mechanical means. Thus, actuating member 30 comprises a length suitable for manual operation by hand. In one embodiment, actuating member 30 comprises a length from about 10 cm to about 20 cm. In a particularly advantageous embodiment, actuating member 30 comprises a length of about 17.7 cm (about 7 inches). Actuating member 30 is also suitably located external of the fluid flow passage thereby isolating the actuating member 30 from any fluid flowing there through.

As shown in FIG. 7, valve assembly 10 comprises an actuating assembly 62 attached to spindle 24 at a first end and attached to the fulcrum 31 at a second end. Actuating assembly 62 is comprised of three or more pivotally linked sections configured so that actuating assembly 62 can be (1) at least partially lengthened as the poppet 28 is being displaced from sealing surface 37, and (2) at least partially folded or collapsed when poppet 28 sealingly abuts sealing surface 37—as shown in FIG. 7.

In a particularly advantageous embodiment, actuating assembly 62 comprises a spindle section 63 including an aperture at one end configured to attach to spindle 24. The aperture of spindle section 63 further includes an internally splined portion which is located over a complimentary splined portion 48 of spindle 24. It should be noted that the alignment of particular splined grooves of spindle section 63 with particular splined grooves of spindle 24 determines the eventual lengthening achieved by the actuating assembly 62, the eventual rotation of spindle 24 and, thus, the total displacement of the poppet 28 from opening 36.

Actuating assembly 62 further comprises an intermediate section 64 that links spindle section 63 to an actuating section 65, configured to attach to actuating member 30. Each of sections 63, 64, and 65 are linked together by linkage pins 66 that allow for folding and lengthening of actuating assembly 62. As shown in FIG. 7, sections 63, 64, and 65 are configured to pivot about linkage pins 66 to set the poppet 28 in a locked position when the valve assembly 10 is in an open position.

Actuating section 65 suitably comprises a quadrilateral or like shape configured so that as the poppet 28 is displaced from opening 36 a portion of actuating section 65 can abut spindle section 63. In a particularly advantageous embodiment, a slight angle is maintained in the alignment between sections 64 and 65 at a locked position. Setting the valve assembly 10 to a locked position not only opens the valve assembly 10, but also frees the user from having to manually apply force to the actuating member during operation of the valve assembly 10.

The rotation of actuating member 30 about fulcrum 31 acts on actuating section 65 to either draw the spindle section 63 and actuating section 65 (a) towards one another, wherein valve assembly 10 is in an open position, or in the alternative, (b) apart, wherein the valve assembly 10 is in a sealed position. When assembling the valve assembly 10, the closer in proximity that the spindle and actuating sections 63, 65 are set, the greater the rotation of spindle 24 prior to the actuating assembly 62 reaching a locked position—thereby determining the ultimate rotation of the lift fork 26 and ultimate amount of displacement of the poppet 28. In operation, actuating member 30 rotates about fulcrum 31, which acts on actuating assembly 62 to further rotate the spindle 24 which in turn pivots the lift fork 26.

Although the valve assembly 10 can be connected to a container by any means apt for fluid communication between the valve assembly 10 and the container, the valve assembly 10 is suitably connected to the container by an industrial fastener configured to releasably secure the valve assembly 10 to the container. Suitable industrial fasteners include, for example, bolts.

The valve assembly 10 described herein is comprised of any material durable enough to seal fluids within a container and control the transfer rate of fluid through the valve assembly 10. In particular, the valve assembly 10 is comprised of materials, including but not necessarily limited to, materials resistant to chipping, cracking, and breaking as a result of ozone, weathering, heat, moisture, other outside mechanical and chemical influences, as well as violent physical impacts. Suitable materials include, for example, composite materials, plastics, ferrous metals, non-ferrous metals, and combinations thereof. In one embodiment, valve assembly 10 comprises stainless steel. In a particularly advantageous embodiment, valve assembly 10 comprises 316 stainless steel suitable for transferring fluids comprising temperatures ranging from about −30° C. to about 210° C. (about −22° F. to about 410° F.).

Suitably, a metal valve assembly can be produced by various processes including, for example, die casting and welding. In a particularly advantageous embodiment, the valve assembly 10 is die cast. Die casting eliminates the problems associated with welding including, for example, rust, corrosion, and material deformation. In addition, the valve assembly 10 can be manufactured to scale and is not limited to any particular size or weight. For exemplary purposes, a suitable stainless steel valve assembly 10 comprises a weight of about 8.8 kg (about 19.3 lb).

Discussion of the Operation of the Valve Assembly

In operation, valve assembly 10 is assembled as illustrated and connected to an outlet point of a container. For most commercial purposes, the primary connecting member 12 connects to a container (1) at a point near the bottom of the container to insure complete or near complete emptying of fluid from the container, wherein (2) the angle of attachment of the primary connecting member 12 to the conduit 20 is about 30° to about 45° relative to the axis of the conduit 20 when conduit 20 is oriented about parallel to the ground or floor.

To begin the fluid transfer process, actuating member 30 is motioned from a first position wherein the distal end of actuating member 30 is about perpendicular to the axis of the conduit 20, to a second position wherein the distal end of actuating member 30 is about parallel to the axis of conduit 20—setting actuating assembly 62 in a locked position.

In a sealed position, poppet 28 abuts sealing surface 37 wherein poppet 28 is centered with opening 36. From a top view of primary connection member 12, as shown in FIG. 8, as the poppet 28 is urged to an open position, the center of poppet 28 (represented by “X”) is displaced off-center from the opening 36 to about the perimeter of opening 36 or to about the sealing surface 37—as predicated by the configuration of the lift fork 26. This is referred to herein as lateral displacement of the poppet 28.

As shown in FIG. 9, as the poppet 28 is displaced to an open position, the poppet body 29 suitably rotates about 45° from a sealed position to an open position. This rotational displacement urges the poppet 28 towards a perpendicular orientation with regard to the plane defining primary connection member 12. As shown in FIG. 8, the combination of lateral and rotational displacement of poppet 28 displaces the center of the poppet 28 to about the sealing surface 37.

Referring again to FIG. 9, when the poppet 28 is displaced to an open position, the poppet 28 and lift fork 26 are substantially outside of the flow path 99 of any fluid being transferred through the body of the valve assembly 10. In other words, the amount of displacement of poppet 28 functions to optimize the rate of fluid transfer through the fluid flow passage of the body of the valve assembly 10, yielding the flow path 99 of fluid substantially unobstructed by the poppet 28 and lift fork 26.

An additional feature of the present application includes controlling the transfer rate of fluid through the fluid flow passage of the body of the valve assembly 10 by adjusting the displacement setting of the poppet 28 along any number of intermediate settings between the sealed position and complete displacement of the poppet 28. The displacement settings of the poppet 28 are a function of the alignment of the splined grooves of spindle section 63 with the splined grooves of spindle 24, and the alignment of the splined portion of spindle 24 with the complimentary internally splined portion 46 of lift fork 26.

The embodiments described above will be better understood with reference to the following non-limiting example, which is illustrative only and not intended to limit the present application to a particular embodiment.

### EXAMPLE 1

In one non-limiting example of the valve assembly disclosed herein, the valve assembly comprises the following approximate dimensions:

Poppet

| | | |
|---|---|---|
| Diameter of Body | 94.5 | mm |
| Height (including Boss) | 35.5 | mm |
| Boss Height | 11.0 | mm |
| O-Ring diameter (unattached from Body) | 82.5 | mm |

Lift Fork

| | | |
|---|---|---|
| Section for Attachment to Poppet (Length) | 59.0 | mm |
| Section for Attachment to Spindle (Length) | 70.0 | mm |
| Outer Diameter of Aperture | 24.5 | mm |
| Inner Diameter of Aperture | 17.0 | mm |

Primary Connection Member (Round)

| | | |
|---|---|---|
| Diameter | 200 | mm |
| Diameter of Opening | 83.0 | mm |

Secondary Connection Member (Square)

| | | |
|---|---|---|
| Length of each side | 142.5 | mm |
| Diameter of Opening | 76.5 | mm |

Elliptical Spacing

| | | |
|---|---|---|
| Diameter | 84.0 | mm |
| Width | 42.0 | mm |

Fork Compartment

| | | |
|---|---|---|
| Depth | 53.0 | mm |
| Width | 25.4 | mm |
| Length | 44.45 | mm |

Conduit

| | | |
|---|---|---|
| Length of sidewall (near fork compartment) | 102 | mm |
| Length of distal sidewall | 136 | mm |
| Length (distal sidewall + elliptical spacing) | 178 | mm |
| Distance from apex of fork compartment to | 75.0 | mm |
| distal sidewall of the conduit | | |

Spindle Housing

| | | |
|---|---|---|
| Inside Length | 158 | mm |

Spindle

| | | |
|---|---|---|
| Length | 178 | mm |
| Diameter (greatest) | 25.0 | mm |
| Diameter (at splined section) | 18.5 | mm |

Actuating Assembly

| | | |
|---|---|---|
| Spindle Section (Length) | 109.5 | mm |
| Intermediate Section (Length) | 79.0 | mm |
| Actuating Section (Length) | 77.0 | mm |

Actuating Member

| | | |
|---|---|---|
| Length | 178 | mm |

Fulcrum

| | | |
|---|---|---|
| Length | 62.0 | mm |
| Diameter (at point of attachment with | 12.0 | mm |
| aperture of actuating member) | | |

As will be understood by those of skill in the art, and others, many modifications may be made without departing from the spirit and scope of the invention. The embodiments described herein are meant to be illustrative only and should not be taken as limiting the invention, which is defined in the following claims.

We claim:

1. A valve assembly comprising:
a body;
a fluid flow passage extending there through;
a lift fork pivotally attached to the body at a first end; and
a poppet attached on its fluid flow passage side to a second end of the lift fork wherein the lift fork is configured to displace the center of the poppet to about the perimeter of the fluid flow passage.

2. The assembly of claim 1, further comprising a fork compartment adjacent and in fluid communication with the fluid flow passage.

3. The assembly of claim 2, further comprising a spindle pivotally mounted through the fork compartment.

4. The assembly of claim 3, wherein the lift fork attaches to the body via spindle at a point within the fork compartment.

5. The assembly of claim 3, further comprising an actuating member for pivoting the spindle.

6. The assembly of claim 4, wherein the fork compartment is configured so that the lift fork can pivot within the fork compartment up to about 100°.

7. The assembly of claim 1, wherein the shape of the lift fork comprises an acute angle.

8. The assembly of claim 1, further comprising a primary connection member.

9. The assembly of claim 8, further comprising a secondary connection member.

10. The assembly of claim 9, wherein primary and secondary connection members are defined by openings there through.

11. The assembly of claim 10, further comprising a conduit defined by a surface which surrounds the conduit, wherein the conduit extends to the primary connection member at one end and to the secondary connection member at an opposing end, said conduit being in fluid communication with the openings of said primary and secondary connection members.

12. The assembly of claim 10, wherein the planes defining the openings of primary and secondary connection members comprise a non-parallel relationship.

13. The assembly of claim 11, further comprising a shear section positioned along the periphery of the conduit at a point where the conduit attaches to the secondary connection member.

14. The assembly of claim 5, further comprising a resilient member linking the spindle to the actuating member.

15. The assembly of claim 14, wherein the resilient member is attached to the exterior of the body of the valve assembly.

16. A valve assembly comprising:
a body;
a fluid flow passage extending there through;
a lift fork pivotally attached to the body at a first end;
a poppet attached on its fluid flow passage side to a second end of the lift fork;
a primary connection member at one end of the fluid flow passage for attaching the valve assembly to a container; and
a secondary connection member at the opposing end of the fluid flow passage;
the shape of the lift fork comprising an acute angle wherein the lift fork is configured to displace the center of the poppet to about the perimeter of the fluid flow passage.

17. The assembly of claim 16, further comprising a fork compartment adjacent and in fluid communication with the fluid flow passage.

18. The assembly of claim 17, wherein the fork compartment is located at a point between primary connection member and secondary connection member.

19. The assembly of claim 17, further comprising a spindle pivotally mounted through the fork compartment.

20. A valve assembly comprising:
a body;
a fluid flow passage extending there through;
a lift fork pivotally attached to the body at a first end; and
a poppet attached on its fluid flow passage side to a second end of the lift fork;
wherein the lift fork is configured to displace the poppet from a first sealed position to a second open position wherein, when the poppet is in an open position, the poppet and lift fork are substantially outside of the flow path of any fluid being transferred through the body of the valve assembly.

21. The assembly of claim 20, further comprising lateral displacement of the poppet.

22. The assembly of claim 20, further comprising rotational displacement of the poppet.

23. The assembly of claim 20, wherein the assembly is configured to control the transfer rate of fluid through the fluid flow passage by adjusting the displacement setting of the poppet.
